(19) United States
(12) Patent Application Publication
(10) Pub. No.: US 2012/0237432 A1
(43) Pub. Date: Sep. 20, 2012

(54) CO2 REFORMING CATALYST, METHOD OF PREPARING THE SAME, AND METHOD OF REFORMING CO2 USING THE CATALYST

(75) Inventors: In Hyuk Son, Yongin-si (KR); Seung Jae Lee, Suwon-si (KR); Hyun Chul Lee, Hwaseong-si (KR); Young Gil Jo, Seongnam-si (KR)

(73) Assignee: SAMSUNG ELECTRONICS CO., LTD., Suwon-si (KR)

(21) Appl. No.: 13/268,263

(22) Filed: Oct. 7, 2011

(30) Foreign Application Priority Data
Mar. 14, 2011 (KR) 10-2011-0022296

(51) Int. Cl. C01B 31/18; B01J 21/04; B01J 23/755; B82Y 30/00

(52) U.S. Cl. 423/418.2; 502/337; 502/335; 977/902

(57) ABSTRACT

A CO₂ reforming catalyst may include a catalyst metal and a porous carrier. The catalyst metal may be at least one metal selected from Ni, Co, Cr, Mn, Mo, Ag, Cu, Zn, and Pd. The catalyst metal may be bonded to the porous carrier to form an alloy.

### CROSS-REFERENCE TO RELATED APPLICATION

This application claims priority under 35 U.S.C. §119 to Korean Patent Application No. 10-2011-0022296, filed in the Korean Intellectual Property Office on Mar. 14, 2011, the entire contents of which are incorporated herein by reference.

### BACKGROUND

1. Field

Example embodiments of the disclosure relate to a CO₂ reforming catalyst, a method of preparing the same, and a method of reforming CO₂.

2. Description of the Related Art

Reduction in the generation of carbon dioxide, which is a leading cause of greenhouse gases, is a globally important problem.

Studies on converting CO₂ into a specific chemical material to create added value are progressing. It may also be a requirement to reduce CO₂ due to CO₂ discharge regulations. CO₂ generation may be reduced and CO₂ may be recycled as a useful chemical material using a method of converting CO₂ and CH₄ into H₂ and CO, which are used as precursors for chemical materials, by a relatively high temperature dry catalyst reaction of CO₂ and CH₄. Such studies are currently underway in chemical plants with regard to oil refining processes where a relatively large amount of CO₂ is generated.

### SUMMARY

Various embodiments relate to a CO₂ reforming catalyst that is thermally stable, has relatively low degradation because coking deposition is reduced during a CO₂ reforming reaction, has desirable activity, and/or is relatively inexpensive.

Various embodiments relate to a method of manufacturing a CO₂ reforming catalyst that is thermally stable, has relatively low degradation because coking deposition is reduced during a CO₂ reforming reaction, and/or is relatively inexpensive.

Various embodiments relate to a CO₂ reforming method using a CO₂ reforming catalyst that is thermally stable, has relatively low degradation because coking deposition is reduced during a CO₂ reforming reaction, and/or is relatively inexpensive.

According to an embodiment, a CO₂ reforming catalyst may include a catalyst metal and a porous carrier. The catalyst metal may be at least one selected from Ni, Co, Cr, Mn, Mo, Ag, Cu, Zn, and Pd. The catalyst metal may be supported on the porous carrier by being bonded to the porous carrier to form an alloy. The catalyst metal may form a straightly cut circle shape or a straightly cut oval or elliptical shape at a cross-section vertical to the bonding side of the catalyst metal and the porous carrier. A height of the catalyst vertical to the bonding side from the straight cutting line of the circle shape or the oval or elliptical shape, when it is defined as ‘h’ , may satisfy the expression h<2r or h<2rₐ, wherein r is a radius of the circle shape, rₐ is a long radius (major radius) of the oval or elliptical shape, and rₐ>r_{b} wherein r_{b} is a short radius (minor radius) of the oval or elliptical shape. The porous carrier may support the catalyst metal such that a bonding surface of the catalyst metal conforms to a supporting surface of the porous carrier. The bonding surface of the catalyst metal may be united with the supporting surface of the porous carrier with an alloy bond.

The catalyst metal having a vertical cross-section of the straightly cut circle shape or the straightly cut oval or elliptical shape may be a partial-sphere (e.g., hemisphere), a partial-ovoid (e.g., half-ovoid), a partial-ellipsoid (e.g., half-ellipsoid), etc.

The porous carrier may be selected from alumina, titania, ceria, silica oxide, and a combination thereof.

The CO₂ reforming catalyst may participate in a CO₂ reforming reaction of the following Reaction Scheme 5.

3CH₄+CO₂+2H₂O→4CO+8H₂ [Reaction Scheme 5]

After the CO₂ reforming catalyst participates in the CO₂ reforming reaction as a catalyst at about 700 to about 850° C. for about 10 to about 100 hours, the particle diameter of the catalyst metal may grow only about 5 to about 10% in a random direction, compared to the particle diameter of the catalyst metal before participating in the CO₂ reforming reaction as a catalyst.

The CO₂ reforming catalyst may have an average longest diameter of the catalyst metal particles of about 2 to 20 nm before participating in the CO₂ reforming reaction as a catalyst.

The CO₂ reforming reaction may be performed with water.

The porous carrier may have a specific surface area of about 20 to about 500 m²/g.

The catalyst metal may be present in a range of about 1 to about 15 wt % relative to the weight of the CO₂ reforming catalyst.

According to another embodiment, a method of manufacturing a CO₂ reforming catalyst may include mixing (e.g., exposing) a porous carrier with a solution of a precursor for at least one catalyst metal selected from Ni, Co, Cr, Mn, Mo, Ag, Cu, Zn, and Pd. The resultant mixture (e.g., precursor-loaded carrier) may be baked so as to prepare a catalyst metal supported on a porous carrier (e.g., metal-loaded carrier). The above-prepared catalyst metal supported on a porous carrier (e.g., metal-loaded carrier) may be oxidized and reduced so as to activate the catalyst metal to form an activated carrier. The activated carrier may be impregnated with water to form an impregnated carrier. The water from the impregnated carrier may be evaporated under a hydrogen atmosphere so as to reduce the catalyst metal, thereby combining the catalyst metal to the porous carrier to form an alloy.

After the catalyst metal is bonded to the porous carrier to form an alloy, the catalyst metal may form a straightly cut circle shape or a straightly cut oval or elliptical shape at a cross-section vertical to the bonding side of the catalyst metal and the porous carrier. A height of the catalyst vertical to the bonding side from the straight cutting line of the circle shape or the oval or elliptical shape, when it is defined as ‘h’ , may satisfy the expression h<2r or h<2rₐ, wherein r is a radius of the circle shape, rₐ is a long radius (major radius) of the oval or elliptical shape, and rₐ>r_{b} when r_{b} is a short radius (minor radius) of the oval or elliptical shape.

The evaporation of water with which the catalyst metal supported on a porous carrier has been impregnated may be performed at about 500 to about 850° C. under hydrogen atmosphere so as to reduce the catalyst metal.

According to yet another embodiment, a method of modifying CO2 may be performed with a catalytic reaction using a CO₂ reforming catalyst with reactants of the following Reaction Scheme 5 of methane, CO₂, and water.

3CH₄+CO₂+2H₂O→4CO+8H₂ [Reaction Scheme 5]

The catalyst metal may be at least one selected from Ni, Co, Cr, Mn, Mo, Ag, Cu, Zn, and Pd. The catalyst metal may be supported on the porous carrier by being bonded to the porous carrier to form an alloy. The catalyst metal may form a straightly cut circle shape or a straightly cut oval or elliptical shape at a cross-section vertical to the bonding side of the catalyst metal and the porous carrier. A height of the catalyst vertical to the bonding side from the straight cutting line of the circle shape or the oval or elliptical shape, when it is defined as ‘h’ , may satisfy the expression h<2r or h<2rₐ, wherein r is a radius of the circle shape, rₐ is a long radius (major radius) of the oval or elliptical shape, and rₐ>r_{b} when r_{b} is a short radius (minor radius) of the oval or elliptical shape.

### BRIEF DESCRIPTION OF THE DRAWINGS

FIG. 1 is a schematic view of a cross-section of a CO₂ reforming catalyst, wherein a catalyst metal is supported on a carrier, according to a non-limiting embodiment.

FIGS. 2(a)-(b) illustrate the shape characteristics of catalyst metal particles on a carrier, with FIG. 2(a) illustrating a catalyst wherein a catalyst metal is physically or chemically adsorbed and supported on a carrier, and FIG. 2(b) illustrating a catalyst wherein a catalyst metal is bonded with a carrier to form an alloy thereon.

FIGS. 3(a)-(i) show the various shapes and dimensions that a catalyst metal may have when alloy bonded to a porous carrier.

FIGS. 4(a)-(b) schematically show changes to the particles caused by sintering after a catalyst metal supported on a carrier participates in a CO₂ reforming reaction.

FIG. 5 is a three-dimensional (3D) TEM image of the catalyst of Example 1.

FIG. 6 is a three-dimensional (3D) TEM image of the catalyst of Comparative Example 1.

FIG. 7 is a graph showing the conversion rate of CH₄ and CO₂ over time when the dry CO₂ reforming reaction of Experimental Example 1 is performed with the CO₂ reforming catalysts prepared in Example 1 and Comparative Example 1.

FIG. 8 is a graph showing the conversion rate of CH₄ and CO₂ over time when the wet CO₂ reforming reaction of Experimental Example 2 is performed with the CO₂ reforming catalysts prepared in Example 1 and Comparative Example 1.

FIG. 9(a)-(b) are SEM photographs of the catalyst of Example 1, taken at different magnifications, after participating in the reforming reaction of Experimental Example 2.

FIGS. 10(a)-(b) are SEM photographs of the catalyst of Comparative Example 1, taken at different magnifications, after participating in the reforming reaction of Experimental Example 2.

FIG. 11 is a thermogravimetric analysis graph of the catalysts of Example 1 and Comparative Example 1, after participating in the wet reforming reaction of Experimental Example 2.

FIG. 12 shows XRD analysis results of the catalysts of Example 1 and Comparative Example 1, after participating in the reforming reaction of Experimental Example 2.

FIGS. 13(a)-(b) are TEM and STEM images of the catalyst of Example 1.

FIGS. 14(a)-(b) are TEM and STEM images of the catalyst of Comparative Example 1.

### DETAILED DESCRIPTION

Various examples will be described more fully hereinafter in the following detailed description, in which some but not all embodiments of this disclosure are described. This disclosure may be embodied in many different forms and is not be construed as limited to the embodiments set forth herein.

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

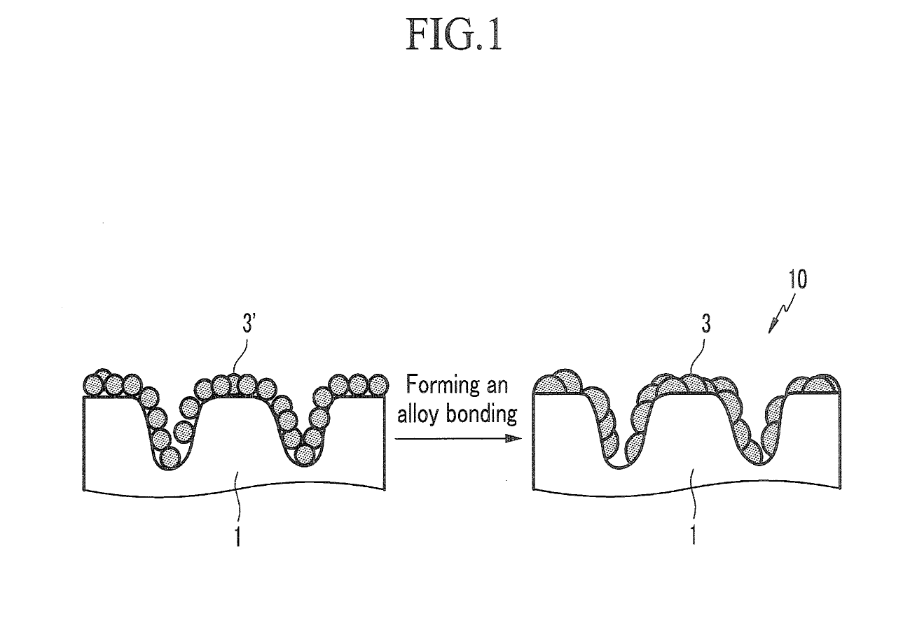

According to an embodiment, the CO₂ reforming catalyst may include a catalyst metal supported on a porous carrier. The catalyst metal may be at least one transition metal. For example, the catalyst metal may be a period 4 and/or a period 5 transition metal. In a non-limiting embodiment, the catalyst metal may be selected from at least one of Ni, Co, Cr, Mn, Mo, Ag, Cu, Zn, and Pd. The catalyst metal and the porous carrier may be bonded to form an alloy. The bond in the form of an alloy may be formed during a manufacturing method of a CO₂ reforming catalyst according to another embodiment. The bond between the carrier and the catalyst metal in the form of an alloy may be formed by causing the catalyst metal (which is physically or chemically adsorbed and thus supported on a porous carrier) to be reduced with water and hydrogen, thereby forming a bond in the form of an alloy between the carrier and the catalyst metal. FIG. 1 shows the bonding cross-section of the catalyst metal and the carrier before and after reduction with water and hydrogen, which may have been exaggerated in order to properly show the difference between the state wherein the catalyst metal is supported on a carrier before the reduction and the state wherein the alloy bonding is formed.

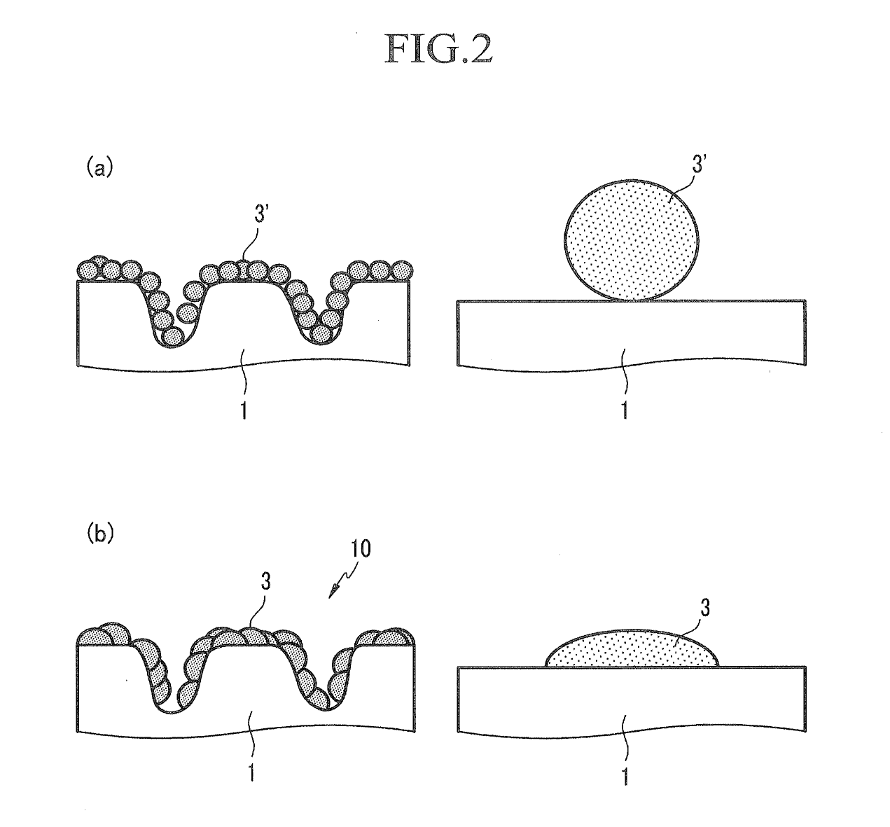

In FIG. 1, the left drawing shows a catalyst in the state wherein the catalyst metal 3′ is physically or chemically adsorbed and thus supported on a porous carrier 1. The right drawing shows the shape of the bond between the porous carrier 1 and the catalyst metal 3 in the form of an alloy in a CO₂ reforming catalyst 10. A bond in the form of an alloy is a relatively strong bond between the catalyst metal 3 and the carrier 1. As a result, the catalyst metal particle 3 may be pressed from the original spherical shape towards the carrier 1 and repressed to contact the carrier 1. FIG. 2 is an exaggerated expanded view of the shape characteristics of catalyst metal particles. FIG. 2(a) shows the case of a catalyst wherein a catalyst metal 3′ is physically or chemically adsorbed and thus supported on a carrier 1. FIG. 2(b) shows the case of a catalyst 10 wherein a catalyst metal 3 is supported on a carrier 1 with a bond in the form of an alloy between the catalyst metal 3 and the carrier 1.

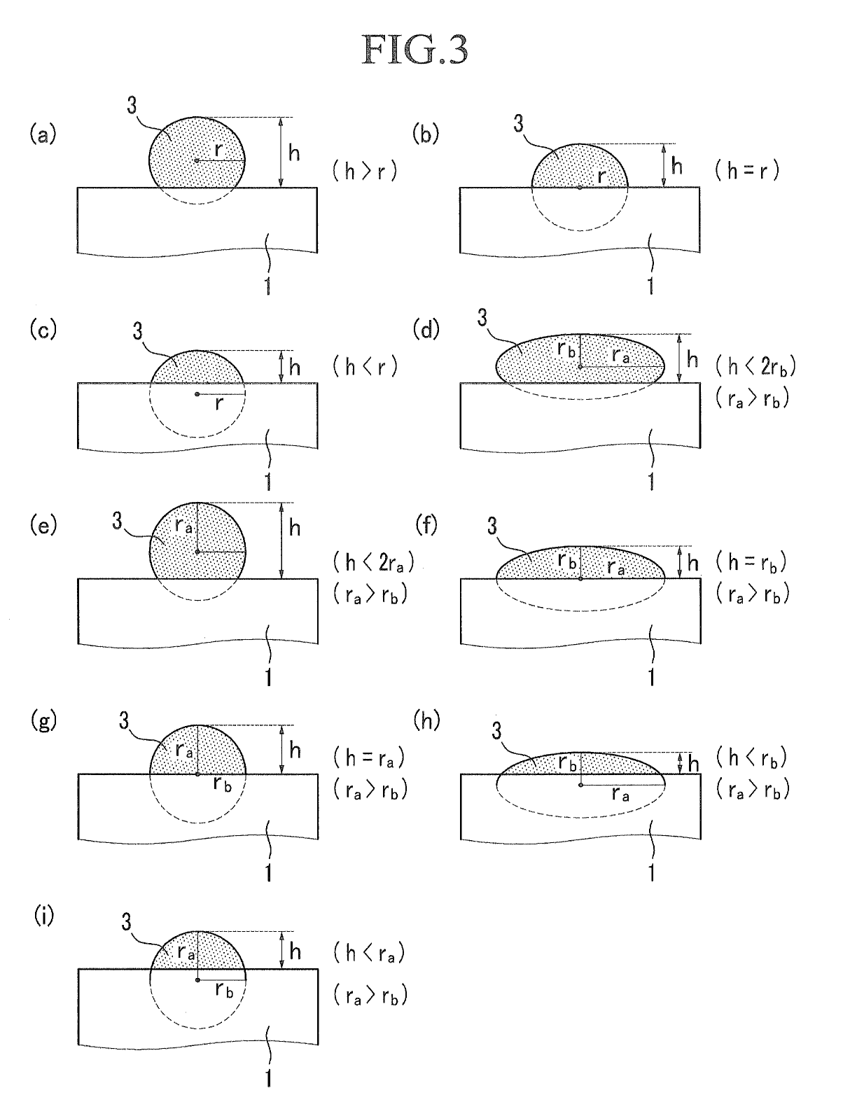

FIGS. 3(a)-(i) show the various shapes and dimensions that a catalyst metal may have when alloy bonded to a porous carrier. It should be understood that various shapes and dimensions referred to herein may be in connection the hypothetical shapes corresponding to the curvature of the catalyst metal that is alloy bonded to a porous carrier. More specifically, the catalyst metal 3 may form a straightly cut circle shape or a straightly cut oval or elliptical shape at a cross-section vertical to the bonding side of the catalyst metal 3 and the porous carrier 1. A height of the catalyst metal 3 vertical to the bonding side from the straight cutting line of the circle shape or the oval or elliptical shape, when defined as ‘h’ , suffices h<2r or h<2rₐ, wherein r is a radius of the circle shape, and rₐ is a long radius (major radius) of the oval or elliptical shape and rₐ>r_{b}, wherein r_{b} is a short radius (minor radius) of the oval or elliptical shape. For example, the catalyst metal 3 having a vertical cross-section of the straightly cut circle shape or the straightly cut oval or elliptical shape may be in the shape of a partial sphere (e.g., hemisphere), a partial-ovoid (e.g, half-ovoid), a partial ellipsoid (e.g., half-ellipsoid), and the like. As shown in FIG. 3(a), h may be greater than r but less than 2r. As shown in FIG. 3(b), h may be equal to r. As shown in FIG. 3(c), h may be less than r. According to another example, as shown in FIG. 3(d), in the case where the cross-section vertical to the bonding side of the catalyst metal 3 and the porous carrier 1 has a cut oval or elliptical shape and the long axis is parallel to the bonding side, h may be less than 2r_{b} (h<2r_{b}). As shown in FIG. 3(e), h may be greater than rₐ and r_{b} but less than 2rₐ. As shown in FIG. 3(f), h may be equal to r_{b}. As shown in FIG. 3(g), h may be equal to rₐ. According to another example, as shown in FIG. 3(h), h may be less than r_{b} (h<r_{b}). Furthermore, according to another example, as shown in FIG. 3(i), in the case where the cross-section vertical to the bonding side of the catalyst metal 3 and the porous carrier 1 has a cut oval or elliptical shape and the short axis is parallel to the bonding side, h may be less than rₐ (h<rₐ).

As explained, since the CO₂ reforming catalyst forms a bond by a relatively strong interaction between the carrier and the catalyst metal, it may be stable at a relatively high temperature. As a result, the growth rate of the catalyst metal before and after participation in a catalyst reaction may be reduced, and degradation due to coking may be reduced.

The CO₂ reforming catalyst may be used as a catalyst for a CO₂ reforming reaction, which will be explained in detail hereinafter.

A mechanism of H₂ and CO generation using a relatively high temperature dry catalyst reaction of CO₂ and CH₄ is a relatively strong endothermic reaction. The reaction may occur at about 700° C. or more. However, a temperature of about 1000° C. or more may not be applied due to an efficiency problem, while a temperature of 850° C. or more may not be applied due to a system efficiency problem. The catalyst has a higher activity at about 700 to about 850° C. than existing catalysts. Thus, a more efficient catalyst reaction may be expected.

CH₄+CO₂→2CO+2H₂ Δ Hₒ=247.3 kJ/mol [Reaction Scheme 1]

CO₂+H₂→CO+2H₂O Δ Hₒ=41 kJ/mol [Reaction Scheme 2]

If the above CO₂ reforming catalyst reaction is used, the reaction temperature may be decreased due to improved activity. As a result, waste heat of the system may be utilized, and the additional heat supply for increasing activity may be relatively small, thus reducing CO₂ discharge. Simultaneously, profit may be created through conversion into a higher added value chemical material.

Together with the above reactions, the reactions of the following Reaction Schemes 3 and 4 occur to generate coking on a catalyst, thus degrading catalyst performance.

CH₄ [symbol] C+2H₂ Δ Ho=122.3 kJ/mol [Reaction Scheme 3]

2CO [symbol] C+CO₂ Δ Ho=125.2 kJ/mol [Reaction Scheme 4]

The Reaction Scheme 3 is a methane decomposition reaction (CH₄ cracking) which is a leading cause of deactivation of the catalyst. The Reaction Scheme 4 is a Boudouard reaction and is of comparatively little importance at a relatively high temperature. Carbon produced by the above reactions may decrease a reaction surface area of a catalyst, may block pores of the carrier, and/or may facilitate decomposition of the carrier, thereby causing deactivation of the catalyst.

As described, the CO₂ reforming catalyst may be stabilized even at a relatively high temperature, and thus has a relatively small growth rate of the particle size of the catalyst metal before and after the CO₂ reforming reaction at a relatively high temperature. Coking by the Reaction Schemes 3 and 4 may be significantly reduced to decrease production of carbon and/or allow the removal of the produced carbon with relative ease. As a result, the life-span and durability of the catalyst may be improved.

Furthermore, a sintering phenomenon wherein the active site of a catalyst is decreased during a relatively high temperature catalyst reaction is also an important catalyst degradation factor. The CO₂ reforming catalyst may significantly decrease sintering by securing thermal stability.

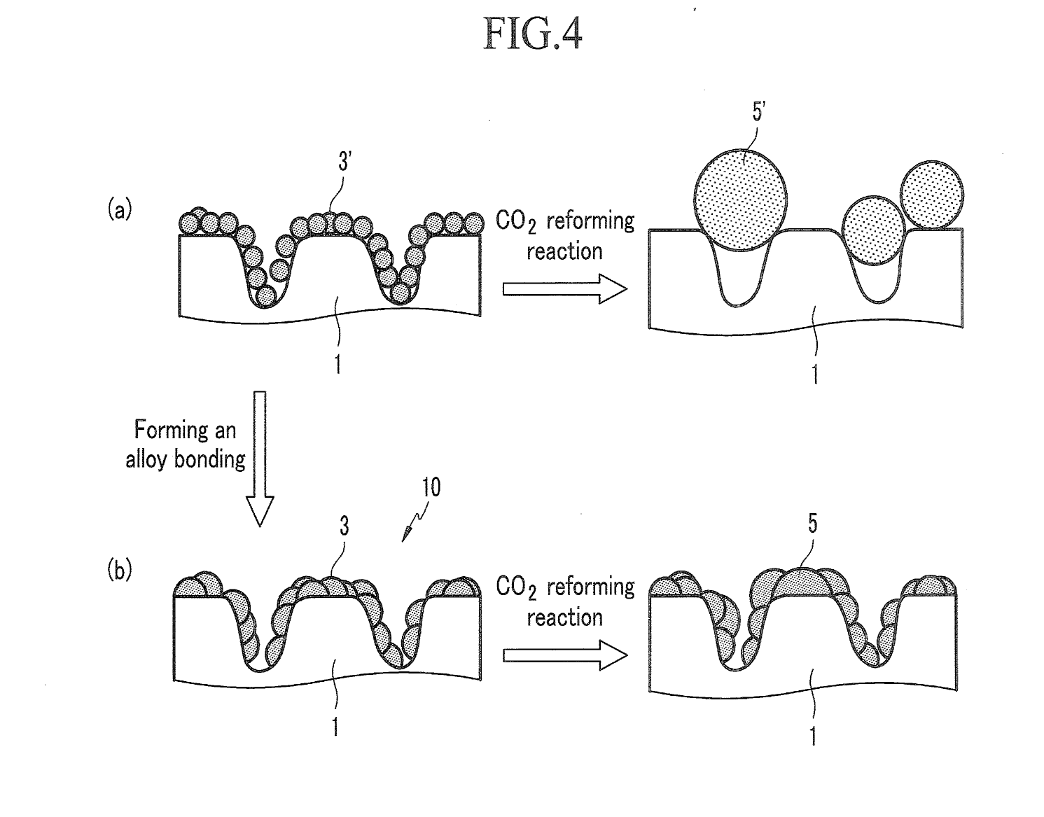

FIG. 4 schematically shows change of particles by sintering after the catalyst supported on a carrier participates in a CO₂ reforming reaction. In FIG. 4(a), after a catalyst wherein a catalyst metal is physically or chemically adsorbed and thus supported on a porous carrier participates in a CO₂ reforming reaction, the particle size of the catalyst metal increases by sintering, and as a result, coking is generated. FIG. 4(b) shows before and after the CO₂ reforming catalyst participates in a CO₂ reforming reaction, wherein, since the alloy bonding is maintained between the carrier and the catalyst metal after the CO₂ reforming reaction, the catalyst particle size increase may be significantly suppressed compared to FIG. 4(a), and as a result, coking may be significantly decreased.

The CO₂ reforming catalyst may be used in a wet catalyst reaction of the CO₂ reforming reaction by the following Reaction Scheme 5.

3CH₄+CO₂+2H₂O→4CO+8H₂ [Reaction Scheme 5]

The CO₂ reforming reaction may be performed with adding water being added, and H₂/CO of a mole ratio of 2 may be obtained in the final product.

According to another embodiment, a method of modifying CO₂ may be performed by a catalyst reaction of the CO₂ reforming catalyst with the reactants of Reaction Scheme 5 of methane, CO₂, and water.

The CO₂ reforming catalyst has a relatively low particle size growth rate of the catalyst metal before and after the catalyst reaction by Reaction Scheme 5. For example, comparing the particle size change of the catalyst metal before and after the CO₂ reforming catalyst participates in the CO₂ reforming reaction of Reaction Scheme 5 as a catalyst at about 700 to about 850° C. for about 10 to about 100 hours, the growth rate may be about 5 to about 10% compared to before the catalyst reaction. The particle size change may be for the radius r of the cross-sectional circle of the catalyst metal, or for the long radius rₐ or short radius r_{b} of the cross-sectional oval. The comparison in length may be at a two-dimensional aspect in any direction.

The CO₂ reforming catalyst may have an average longest diameter of the catalyst metal particle of about 3 to about 20 nm before participating in the CO₂ reforming reaction.

However, coking generation may be influenced by the catalyst metal particle size change before and after the catalyst reaction rather than the absolute size of the catalyst metal particle before the catalyst reaction.

The catalyst metal may be selected from Ni, Co, Cr, Mn, Mo, Ag, Cu, Zn, Pd, and a combination thereof.

The catalyst metal selected from Ni, Co, Cr, Mn, Mo, Ag, Cu, Zn, and Pd is favorable in terms of cost compared to a noble metal catalyst metal, and exhibits relatively high temperature stability and thus is useful as a CO₂ reforming reaction catalyst at a relatively low temperature.

The porous carrier may be selected from alumina, titania, ceria, silica oxide, and a combination thereof.

In the CO₂ reforming catalyst, if alumina, silica, or the like is used as the carrier, a stable γ shape may be maintained even after participation in a relatively high temperature catalyst reaction due to a rigid carrier characteristic, thus exhibiting desirable durability and life-span characteristics of the catalyst.

In the CO₂ reforming catalyst, it may be favorable that the porous carrier has a larger specific surface area. For example, the porous carrier may have a specific surface area of about 20 to about 500 m²/g, and specifically about 100 to about 500 m²/g.

The degree of activation of the CO₂ reforming catalyst may be influenced by the loading of the catalyst metal. For example, in the CO₂ reforming catalyst, the supported concentration of the catalyst metal may be about 1 to about 15 wt %, and specifically about 4 to about 8 wt % relative to the overall CO₂ reforming catalyst.

Hereinafter, a method of manufacturing the CO₂ reforming catalyst will be explained in detail.

According to an embodiment, a method of manufacturing a CO₂ reforming catalyst may include mixing a porous carrier with a solution of a precursor for at least one catalyst metal selected from Ni, Co, Cr, Mn, Mo, Ag, Cu, Zn, and Pd, and then baking a resultant mixture so as to prepare a catalyst metal supported on a porous carrier; oxidizing and reducing the above-prepared catalyst metal supported on a porous carrier so as to activate the catalyst metal; impregnating the activated catalyst metal supported on the porous carrier with water; and evaporating the water with which the catalyst metal supported on a porous carrier has been impregnated under a hydrogen atmosphere so as to reduce the catalyst metal, thereby combining the catalyst metal to the porous carrier to form an alloy.

The shape of the catalyst metal bonded to the porous carrier in the form of an alloy may be controlled by the temperature of the process, wherein the catalyst metal to be reduced by evaporating the water with which the catalyst metal supported on a porous carrier has been impregnated under a hydrogen atmosphere. For example, the evaporation of water with which the catalyst metal supported on a porous carrier has been impregnated under a hydrogen atmosphere so as to reduce the catalyst metal may be performed at about 500 to about 850° C.

Hereinafter, various embodiments are illustrated below in more detail. However, it should be understood that the following are merely examples and should not be construed to limit the scope of the disclosure.

### EXAMPLE

### Example 1

A 7 wt % Ni/γ-Al₂O₃ catalyst is prepared by an initial wet method. Alumina (150 m²/g, diameter of alumina granule: the diameter of the alumina granule is 3 mm or less of, Alfa) is impregnated with an aqueous solution of Ni(NO₃)₂.H₂O (Samchun Chemical Co.), and then it is dried in an oven at about 120° C. for about 24 hours, and baked at about 500° C. under an air atmosphere for about 5 hours. The baked catalyst is reduced under a nitrogen atmosphere while elevating the temperature (by about 10° C./min), and is subsequently maintained at about 850° C. under a hydrogen atmosphere for about 1 hour to prepare a 7 wt % Ni/γ-Al₂O₃ catalyst. The reactor is cooled to about 30° C., and about 5 ml of distilled water is added to the catalyst. Subsequently, water is evaporated under a hydrogen atmosphere while elevating the temperature (by about 10° C./min), and the catalyst is maintained at about 850° C. for about 1 hour.

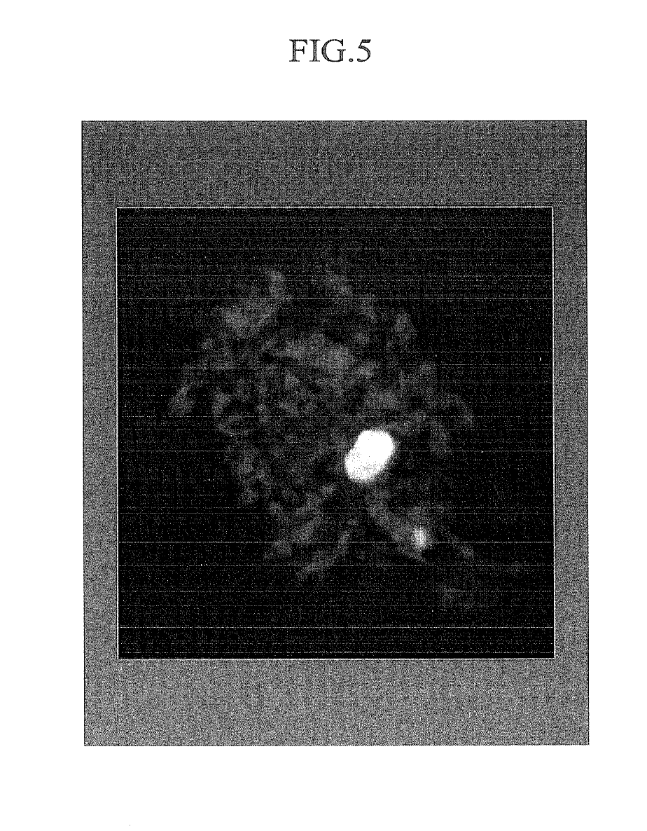

For the above-prepared catalyst, a three-dimensional (3D) TEM image is taken to confirm the shape of the supported catalyst metal, and the cross-section is analyzed to analyze the cross-section of the metal catalyst supported on a carrier. FIG. 5 shows a cross-section of the above 3D TEM image. It is shown that the bonding cross-section of the catalyst metal has a hemispherical, ovoidal, or ellipsoidal shape, and the catalyst metal forms an alloy bonding with the carrier by the interaction with the carrier.

### Comparative Example 1

A 7 wt % Ni/γ-Al₂O₃ catalyst is prepared by an initial wet method. Alumina (150 m²/g, diameter of alumina granule: the diameter of the alumina granule is 3 mm or less, Alfa) is impregnated with an aqueous solution of Ni(NO₃)₂.H₂O (Samchun Chemical C.), and then it is dried in an oven at about 120° C. for about 24 hours and dried, and baked at about 500° C. under an air atmosphere for about 5 hours. The baked catalyst is reduced under a nitrogen atmosphere while elevating the temperature (by about 10° C./min), and is subsequently maintained at about 850° C. under a hydrogen atmosphere for about 1 hour to prepare a 7 wt % Ni/γ-Al₂O₃ catalyst.

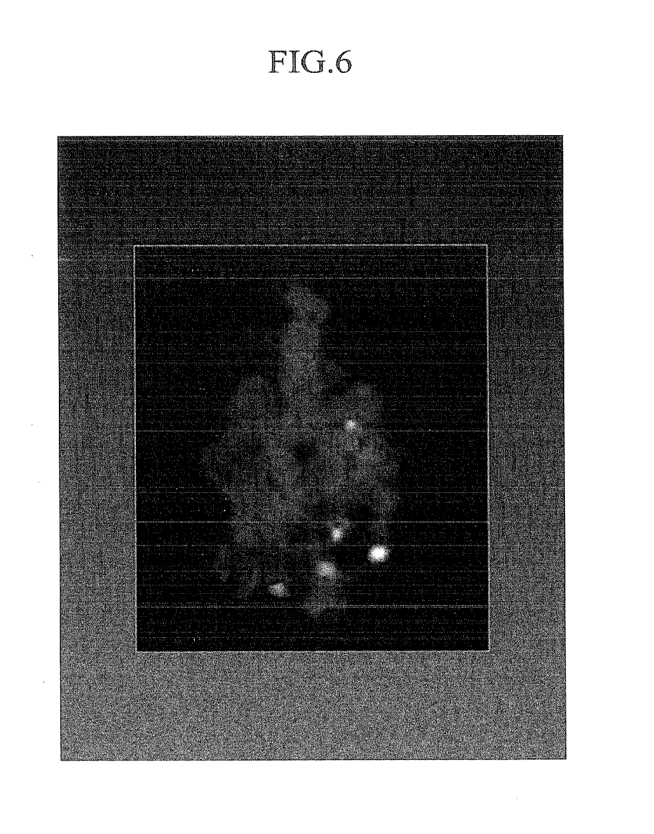

As in Example 1, for the above-prepared catalyst, a three-dimensional (3D) TEM image is taken to confirm the shape of the supported catalyst metal, and to allow an analysis of the cross-section of the metal catalyst supported on a carrier. FIG. 6 is a cross-section of the 3D TEM image. It is shown that the catalyst metal exists in a spherical shape, indicating that it is merely adsorbed without an interaction with the carrier.

### Experimental Example 1

A dry reforming reaction of CO₂ and CH₄ is performed with the catalysts prepared in Example 1 and Comparative Example 1 by the following Reaction Schemes 1 and 2. For about 0.45 g of each catalyst prepared in Example 1 and Comparative Example 1, reactants CH₄, CO₂, and nitrogen are respectively introduced at about 200 sccm (standard cubic centimeters per minute) at about 850° C., and the reaction is performed for about 10 hours (gas hourly space velocity (GHSV)=25 k cc/g·hr).

CH₄+CO₂→2CO+2H₂ [Reaction Scheme 1]

CO₂+H₂→CO+2H₂O [Reaction Scheme 2]

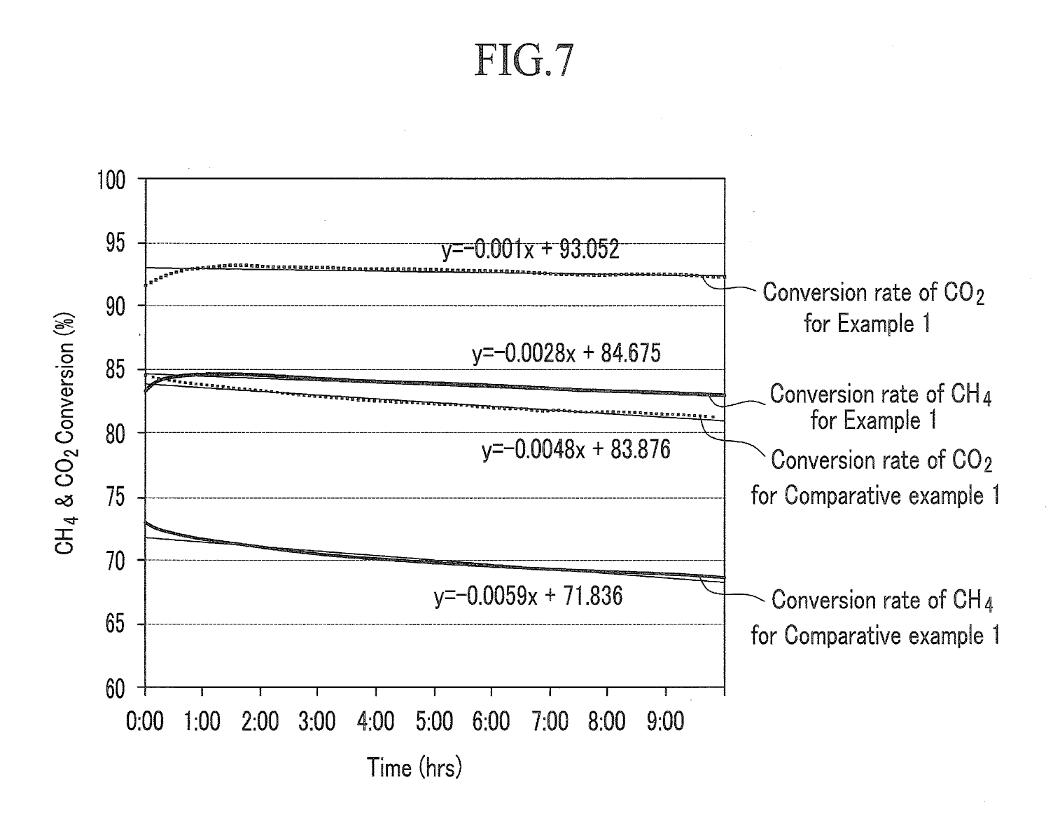

Conversion rate of CH₄ and CO₂ over time is shown in FIG. 7, and a function is indicated by linear regression analysis, while degradation degree of the catalyst is confirmed by the slope.

### Experimental Example 2

A wet reforming reaction of CO₂ and CH₄ is performed with the catalysts prepared in Example 1 and Comparative Example 1 by the following Reaction Scheme 5. For about 0.45 g of each catalyst prepared in Example 1 and Comparative Example 1, reactants CH₄, CO₂, and nitrogen are introduced respectively at about 200 sccm (standard cubic centimeter per minute) at about 850° C., and the reaction is performed for about 10 hours (gas hourly space velocity (GHSV)=25 k cc/g·hr).

3CH₄+CO₂+2H₂O→4CO+8H₂ [Reaction Scheme 5]

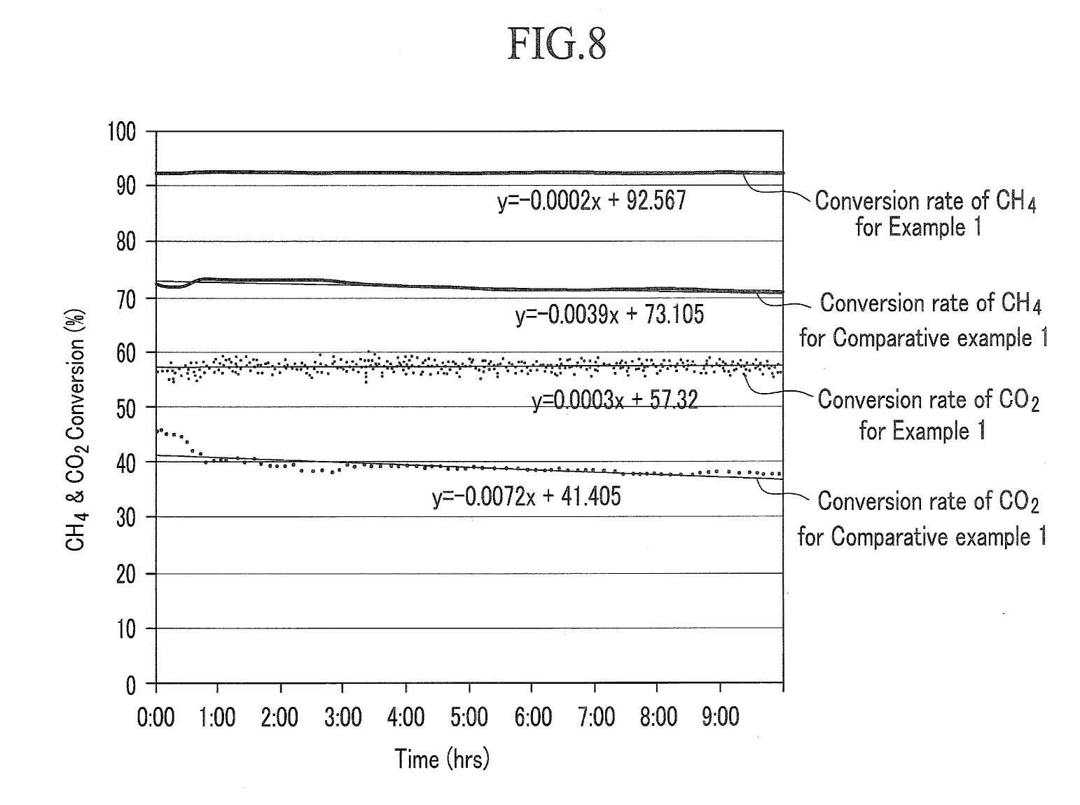

Conversion rate of CH₄ and CO₂ over time is shown in FIG. 8, and a function is indicated by linear regression analysis, while degradation degree of the catalyst is confirmed by the slope.

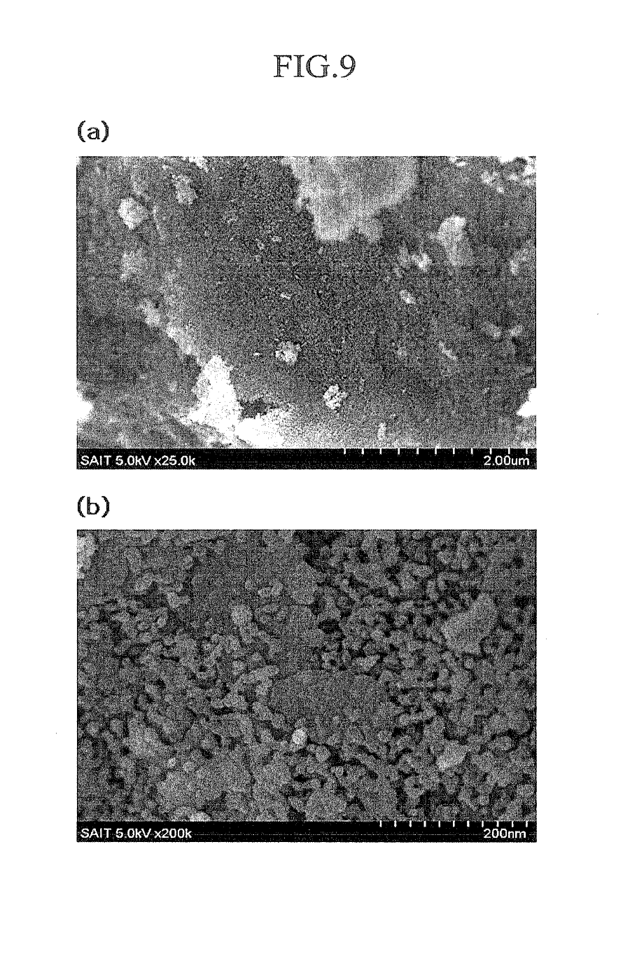

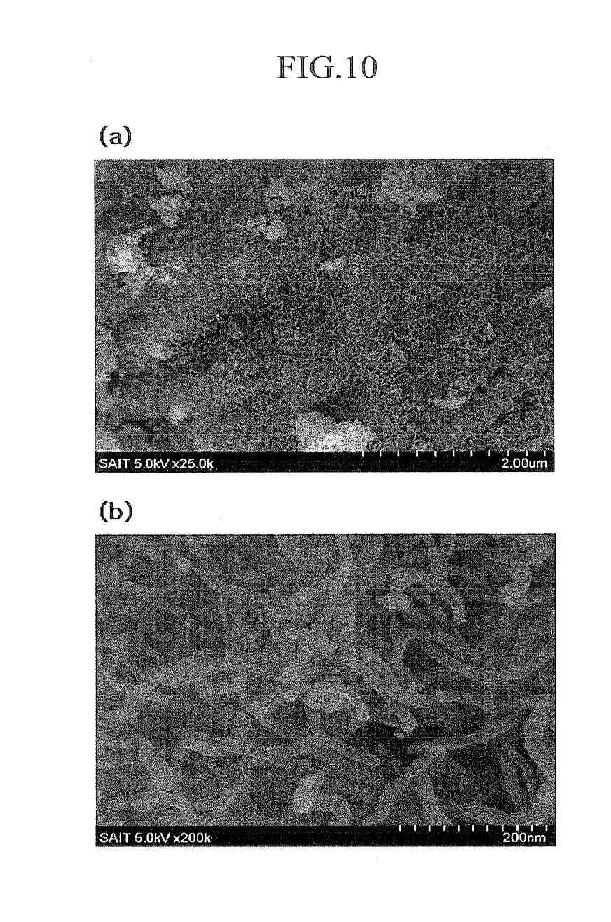

FIGS. 9(a) and (b) are SEM photographs of the catalyst of Example 1 after participating in the reforming reaction of Experimental Example 2, with different magnification. FIGS. 10(a) and (b) are SEM photographs of the catalyst of Comparative Example 1 after participating in the reforming reaction of Experimental Example 2, with different magnification. FIG. 10 shows that the catalyst of Comparative Example 1 is wire-shaped and coking is seriously generated. On the other hand, it is confirmed by FIG. 9 that in the catalyst of Example 1, coking is significantly reduced.

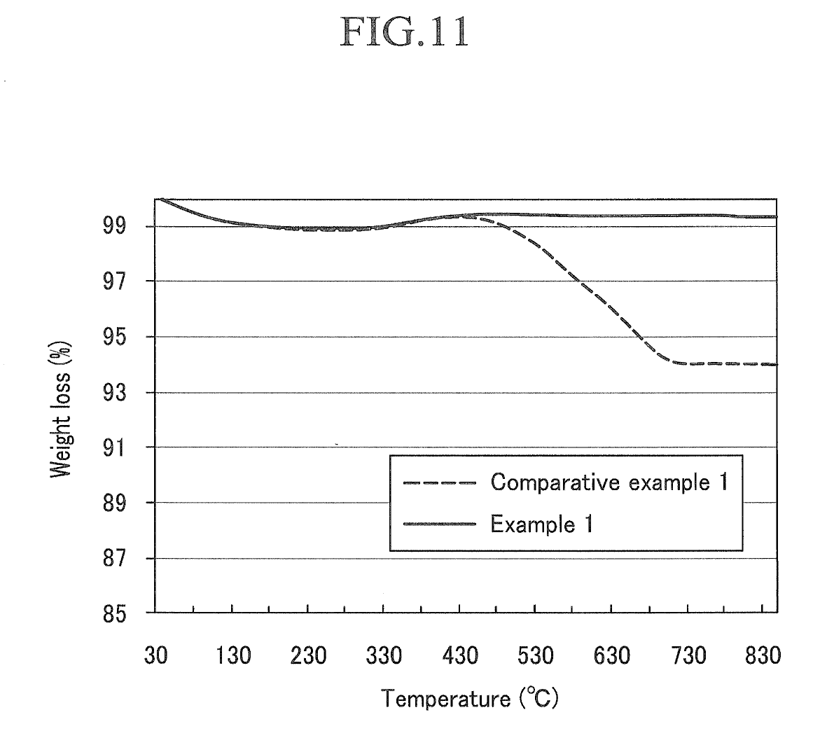

FIG. 11 is a thermogravimetric analysis graph of the catalysts of Example 1 and Comparative Example 1, after performing the reforming reaction of Experimental Example 2 for about 10 hours. The generation of weight loss in Comparative Example 1 means that coking occurs. To the contrary, it is confirmed that in Example 1, weight loss does not substantially occur and thus coking is not substantially generated.

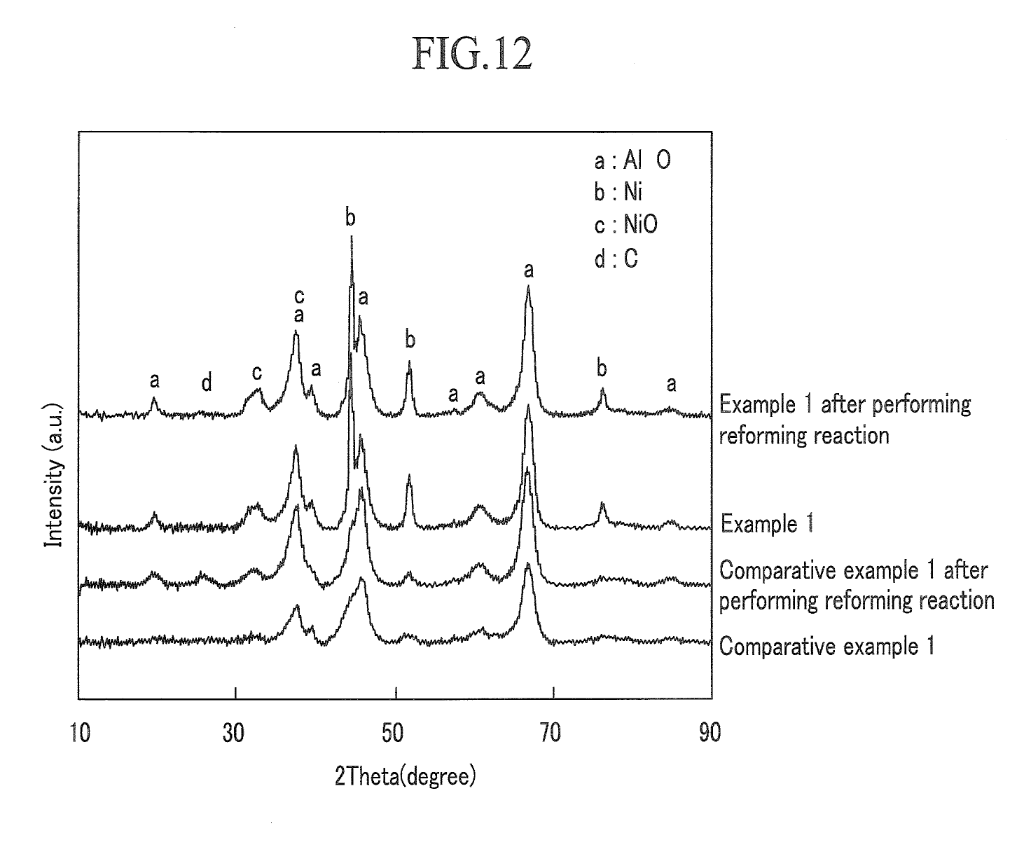

FIG. 12 shows XRD analysis results of the catalysts of Example 1 and Comparative Example 1, after participating in the reforming reaction of Experimental Example 2. The bottom line in FIG. 12 is for the catalyst prepared in Comparative Example 1, and the second line from the bottom is for the catalyst of Comparative Example 1 after participating in the reforming reaction of Experimental Example 2. A d peak is generated in the catalyst of Comparative Example 1 after the reforming reaction, thus confirming that coking is generated. Meanwhile, the second line from the top in FIG. 12 is for the catalyst of Example 1, and the top line is for the catalyst of Example 1 after participating in the reforming reaction of Experimental Example 2. It is confirmed that a very slight d peak is generated in the catalyst of Example 1 after the reforming reaction. Thus, it can be seen that coking is very slightly generated in the catalyst of Example 1 during the reforming reaction.

Meanwhile, for each catalyst of Example 1 and Comparative Example 1 before and after participating in the reforming reaction of Experimental Examples 1 and 2, a transmission electron microscope photograph (TEM) and a scanning transmission electron microscope photograph (STEM) were taken to measure Ni particle size change.

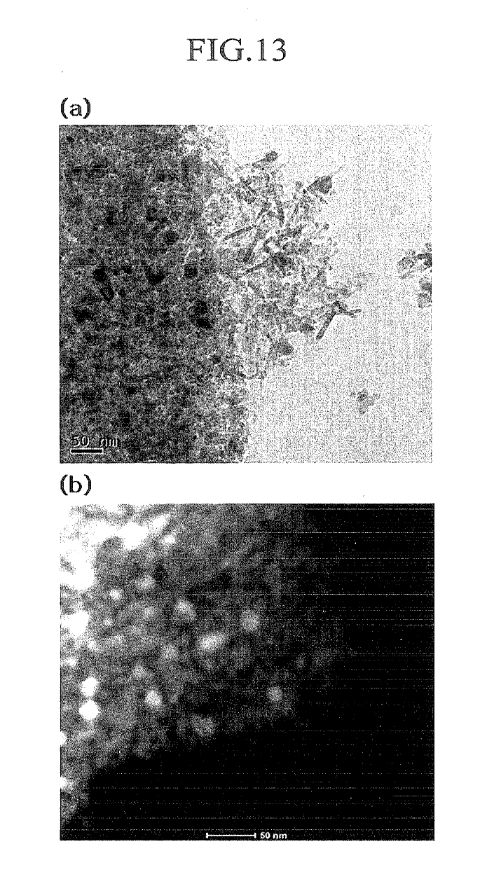

FIG. 13(a) is a TEM photograph of the catalyst of Example 1 after participating in the reforming reaction of Experimental Example 2, and FIG. 13(b) is an STEM converted image. In FIG. 13(b), the catalyst metal Ni is exposed as a white particle.

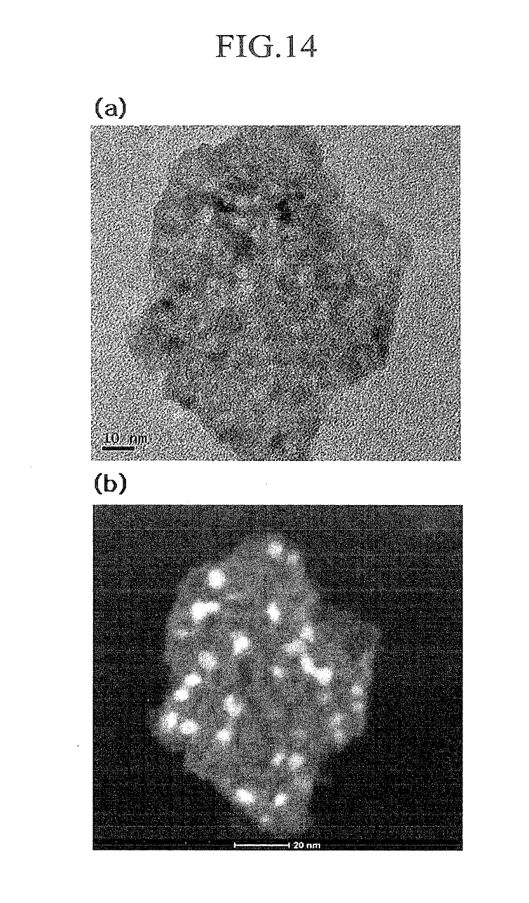

FIG. 14(a) is a TEM photograph of the catalyst of Comparative Example 1 after participating in the reforming reaction of Experimental Example 2, and FIG. 14(b) is an STEM converted image. In FIG. 14(b), the catalyst metal Ni is exposed as a white particle.

The catalyst particle size is measured in the STEM image, and the results are described in the following Table 1.

TABLE 1

| | Average size of Ni particle (nm) | |
|---|---|---|
| | Example 1 | Comparative Example 1 |
| Before participating in the | 16 | 6.4 |
| reforming reaction | | |
| After participating in the | 16 | 9 |
| reforming reaction of | | |
| Experimental Example 1 | | |
| After participating in the | 16 | 11 |
| reforming reaction of | | |
| Experimental Example 2 | | |

According to the results of Table 1, in the catalyst of Comparative Example 1, a catalyst particle grows after participating in the reforming reaction, while in the catalyst of Example 1, there does not appear to be a measurable size change between before and after participating in the reforming reaction.

While various examples have been disclosed herein, it is to be understood that the disclosure is not limited to the disclosed embodiments. Instead, the disclosure is intended to cover a number of modifications and equivalent arrangements included within the spirit and scope of the appended claims.

What is claimed is:

1. A CO₂ reforming catalyst, comprising:
a catalyst metal, the catalyst metal being at least one of Ni, Co, Cr, Mn, Mo, Ag, Cu, Zn and Pd; and
a porous carrier supporting the catalyst metal such that a bonding surface of the catalyst metal conforms to a supporting surface of the porous carrier, the bonding surface of the catalyst metal being united with the supporting surface of the porous carrier with an alloy bond, the catalyst metal having a cross-section of a circular, elliptical, or oval shape, the cross-section defined by a plane extending through a center of the catalyst metal and extending perpendicularly to the supporting surface of the porous carrier, the catalyst metal having a height designated as h, the height being a vertical distance from an uppermost surface of the catalyst metal to the supporting surface of the porous carrier, the circular, elliptical, or oval shape of the cross-section having at least one of a radius designated as r, a major radius designated as rₐ, and a minor radius designated as r_{b}, the major radius rₐ being greater than the minor radius r_{b}, the height of the catalyst metal satisfying the relationship h<2r or h<2rₐ.

2. The CO₂ reforming catalyst of claim 1, wherein the catalyst metal has a shape of a partial-sphere, a partial-ellipsoid, or a partial-ovoid.

3. The CO₂ reforming catalyst of claim 1, wherein the porous carrier is at least one material selected from alumina, titania, ceria, and silica oxide.

4. The CO₂ reforming catalyst of claim 1, wherein the CO₂ reforming catalyst is configured to facilitate a CO₂ reforming reaction of the following Reaction Scheme 5:
3CH₄+CO₂+2H₂O→4CO+8H₂. [Reaction Scheme 5]

5. The CO₂ reforming catalyst of claim 4, wherein the catalyst metal is configured such that a growth of the catalyst metal is about 5 to about 10% after the CO₂ reforming catalyst facilitates the CO₂ reforming reaction at about 700 to about 850° C. for about 10 to about 100 hours.

6. The CO₂ reforming catalyst of claim 1, wherein the catalyst metal is in a form of particles having an average diameter of about 2 to 20 nm.

7. The CO₂ reforming catalyst of claim 1, wherein the CO₂ reforming catalyst is configured to facilitate the CO₂ reforming reaction in the presence of water.

8. The CO₂ reforming catalyst of claim 1, wherein the porous carrier has a specific surface area of about 20 to about 500 m²/g.

9. The CO₂ reforming catalyst of claim 1, wherein the catalyst metal is present in a range of about 1 to about 15 wt % relative to the weight of the CO₂ reforming catalyst.

10. A method of manufacturing a CO₂ reforming catalyst, the method comprising:
exposing a porous carrier to a solution containing a precursor of a catalyst metal to form a precursor-loaded carrier, the catalyst metal being at least one of Ni, Co, Cr, Mn, Mo, Ag, Cu, Zn, and Pd;
baking the precursor-loaded carrier to form a metal-loaded carrier;
oxidizing and reducing the metal-loaded carrier to activate the catalyst metal to form an activated carrier;
impregnating the activated carrier with water to form an impregnated carrier; and
evaporating the water from the impregnated carrier under a hydrogen atmosphere to reduce the catalyst metal to form an alloy bond between the catalyst metal and the porous carrier.

11. The method of claim 10, wherein the evaporating the water includes forming a bonded catalyst metal particle with a height h from a surface of the porous carrier such that h<2r or h<2rₐ, r being a radius of a hypothetical sphere corresponding to a curvature of the catalyst metal particle, and rₐ being a major radius of a hypothetical ellipsoid corresponding to the curvature of the catalyst metal particle.

12. The method of claim 10, wherein the evaporating the water is performed at about 500 to about 850° C.

13. A method of modifying CO₂, the method comprising:
performing a catalytic reaction with a CO₂ reforming catalyst according to the following Reaction Scheme 5,
3CH₄+CO₂+2H₂O→4CO+8H₂ [Reaction Scheme 5]
the CO₂ reforming catalyst including a catalyst metal and a porous carrier, the catalyst metal being at least one of Ni, Co, Cr, Mn, Mo, Ag, Cu, Zn, and Pd, the porous carrier supporting the catalyst metal such that a bonding surface of the catalyst metal conforms to a supporting surface of the porous carrier, the bonding surface of the catalyst metal being united with the supporting surface of the porous carrier by an alloy bond, the catalyst metal having a cross-section of a circular, elliptical, or oval shape, the cross-section defined by a plane extending through a center of the catalyst metal and extending perpendicularly to the supporting surface of the porous carrier, the catalyst metal having a height designated as h, the height being a vertical distance from an uppermost surface of the catalyst metal to the supporting surface of the porous carrier, the circular, elliptical, or oval shape of the cross-section having at least one of a radius designated as r, a major radius designated as rₐ, and a minor radius designated as r_{b}, the major radius rₐ being greater than the minor radius r_{b}, the height of the catalyst metal satisfying the relationship h<2r or h<2rₐ.
